(19) United States
(12) Patent Application Publication
(10) Pub. No.: US 2010/0148675 A1
(43) Pub. Date: Jun. 17, 2010

(54) METHOD AND SYSTEM FOR CONTROLLING THE OUTPUT OF A LUMINAIRE

(75) Inventors: Eduard Johannes Meijer, Eindhoven (NL); Ronald Dekker, Eindhoven (NL); Eugene Timmering, Eindhoven (NL); Peter Hubertus Franciscu Deurenberg, Eindhoven (NL); Matthias Wendt, Wuerselen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/993,480

(22) PCT Filed: Jun. 26, 2006
(86) PCT No.: PCT/IB2006/052083

§ 371 Date: Dec. 21, 2007

(30) Foreign Application Priority Data
Jun. 30, 2005 (EP) 05105945.9

(51) Int. Cl. H05B 37/02

(52) U.S. Cl. 315/152

(57) ABSTRACT

The present invention relates to a method of controlling the output of a luminaire comprising an array of LEDs emitting light of at least one color. The array has single color LED groups, wherein each group consists of at least one LED. The method comprises the following steps for each LED group:spectrally filtering the light emitted by the LED group by means of a first filter as well as by means of a second filter; detecting the spectrally filtered light from said first and said second filter and generating respective first and second response signals, wherein the levels of said first and second response signals are related to the respective amounts of detected spectrally filtered light; and controlling the light output of said LED group on the basis of said first and second response signals, wherein the filter characteristics of said first and said second filter are at least partly non-overlapping. The invention also relates to a corresponding control system for performing the method.

The present invention relates to a method of controlling the output of a luminaire comprising an array of LEDs emitting light of at least one color, the array comprising single color LED groups, wherein each group consists of at least one LED.

Luminaires based on red, green, and blue (RGB) light-emitting diodes (LEDs) generate various colors of light which, when properly combined, produce white light. Other colors generated by an RGB combination are also preferred in some applications. RGB LED luminaires are used in, for example, LCD back-lighting, commercial-freezer lighting, and white light illumination.

Illumination by means of LED-based luminaires presents difficulties because the optical characteristics of individual RGB LEDs vary with temperature, forward current, and aging. In addition, the characteristics of individual LEDs that are meant to be equal vary as well. More particularly, they vary significantly from batch to batch for the same LED fabrication process and from manufacturer to manufacturer. Consequently, the quality of the light emitted from RGB-based LED luminaires can vary significantly, and the desired color and the required light intensity of the white light may not be obtained without a suitable light output control system.

U.S. Pat. No. 6,630,801 discloses a LED luminaire including red, green, and blue LED light sources, each consisting of a plurality of LEDs driven by an independent driver. The light emitted from each LED light source is detected by a respective filtered photodiode and an unfiltered photodiode. The response signals are correlated to chromaticity coordinates for each LED light source. Forward currents driving the respective LED light sources are adjusted in accordance with differences between the chromaticity coordinates of each LED light source and corresponding coordinates of a desired mixed color light. While compensating the varying LED properties of the RGB LED luminaire to some extent, this method is unable to discriminate between spectral shifts, spectral broadening and intensity changes.

It is an object of the present invention to provide a method and an apparatus for controlling the light output of a LED luminaire which alleviates the above-mentioned drawbacks of the prior art.

According to the present invention, this object is achieved by a method as defined in claim 1 and by a control system as defined in claim 20.

The invention is based on the recognition that the use of two spectrally filtered photosensors, with filters that are properly designed in relation to each other and to an assumed spectrum of a LED light source, provides the possibility of determining parameters of the actually detected spectrum that are useful for controlling the LED light source in an accurate way.

Thus, in accordance with an aspect of the present invention, a method of controlling the light output of a luminaire comprising an array of LEDs emitting light of at least one color, the array comprising single color LED groups, wherein each group consists of at least one LED, comprises the following steps for each LED group:

spectrally filtering the emitted light by means of a first filter as well as by means of a second filter;

detecting the spectrally filtered light from said first and said second filter and generating respective first and second response signals, wherein the levels of said first and second response signals are related to the respective amounts of detected spectrally filtered light; and

controlling the light output of said LED group on the basis of said first and second response signals,

wherein the filter characteristics of said first and said second filter are at least partly non-overlapping, and the filter characteristics of said first and said second filter at least partly cover different portions of the spectrum of the light emitted by the LED group.

The wording “on the basis of said first and second response signals” is to be interpreted as “by means of at least”, i.e. there may be more information that is used in conjunction with the responses.

In accordance with embodiments of the method as defined in claims 3 and 4, the LED luminaire light output control uses a peak wavelength and a FWHM (Full Width at Half Maximum), respectively, of the LED group spectrum, calculated from the response signals. In accordance with an embodiment of the method as defined in claim 5, the LED spectrum is estimated on the basis thereof. For this estimation, preferably a shape of the LED spectrum is assumed and used for calculating said estimated spectrum. The LED spectrum can then be used for determining the color point of the LED group. This information is useful when controlling the output of the LED group in order to more accurately obtain a desired color point, for example, associated with an input made by a user.

Another way of generating a basis for control adjustments is to simply determine the ratio between the response signal levels, as defined in claim 8.

In accordance with an embodiment of the method as defined in claim 10, the control includes moving the LED spectrum towards longer or shorter wavelengths, for example, by adjusting the drive current of the LED or LEDs of the LED group, or by changing the temperature of the LED group, or both, until a predetermined relation between the response signals has been obtained. This is also known as pinning the LED spectrum. This relationship can be determined in different ways, such as by comparison or by calculating a ratio between response levels.

The LED group spectrum is pinned midway between the spectral characteristics of the first and the second filter, or at another specific spectral position. It should be noted that the wording “midway between the spectral characteristics” is of course dependent on the type of filters used, as will be further explained below.

In accordance with embodiments of the method, different filter types and combinations of filter types are possible. However, typical combinations are a low-pass filter and a high-pass filter, two bandpass filters, which have a different spectral response, or two narrow-band filters, which have a different spectral response.

According to an embodiment of the method as defined in claim 17, the filters are Fabry-Perot etalons. Due to their narrow-band response, they are less sensitive to stray ambient light than broadband filters. In this embodiment, it is possible to choose different narrow-band combinations by tuning the filters by changing the thickness or refractive index of the dielectric layer that makes up the resonant cavity in the Fabry-Perot etalon. Use of higher resonances of the filter response also allows a single filter to be used in different parts of the visible spectrum.

According to an embodiment of the method as defined in claim 18, a total intensity of the LED group is detected additionally. This increases the capability of detecting a change of the light intensity of the LED group in a spectrally symmetric way.

Furthermore the duty cycle for the LED group can be controlled by combining the knowledge of the total intensity and the color point, acquired as described above. Since the LEDs are typically pulsed, the duty cycle is the ratio between the pulse duration and the pulse period. When a plurality of colors are combined, a desired mixed color point is set by controlling the individual LED groups appropriately, including individual setting of their duty cycles.

Using two spectrally filtered photodetectors, which are properly designed in relation to a predefined spectrum of a LED light source, and an unfiltered photodetector, the invention further provides the possibility of determining an amount of a deviation between the actually emitted, i.e. detected, spectrum and the predefined one, both in the full-width-at-half-maximum of the detected spectrum, the peak wavelength position and intensity of the detected spectrum. The present invention also provides the possibility of determining the full-width-at-half-maximum of the detected spectrum, the peak wavelength position and intensity of the detected spectrum spectral without knowledge of the details of the predefined spectrum, but only with knowledge of the general spectral shape of the LED output.

In accordance with another aspect of the present invention, a control system is provided for controlling the output of a luminaire comprising an array of LEDs emitting light of at least one color, the array comprising single color LED groups, wherein each group consists of at least one LED. The system comprises, for each LED group:

a first spectral filter and a second spectral filter arranged to receive the light emitted from the LED group;

a first photodetector optically connected with said first spectral filter, and a second photodetector optically connected with said second spectral filter, wherein said first and said second photodetector are arranged to detect spectrally filtered light, which has passed said first and said second spectral filter, respectively, and to generate first and second response signals, respectively, wherein the levels of said first and second response signals are related to a respective amount of the detected spectrally filtered light; and

a control device, connected with said first and said second photodetector and arranged to control the light output of said LED group on the basis of said first and second response signals, wherein the filter characteristics of said first and said second filter are at least partly non-overlapping.

This system is arranged to perform the method described above, and presents corresponding advantages.

It is to be noted that within the scope of the invention, the determinations of peak wavelength and FWHM can be based on the two spectrally filtered response signals as well as on these signals in combination with the unfiltered response signal.

These and other aspects, features, and advantages of the invention are apparent from and will be elucidated with reference to the embodiments described hereinafter.

In the drawings,

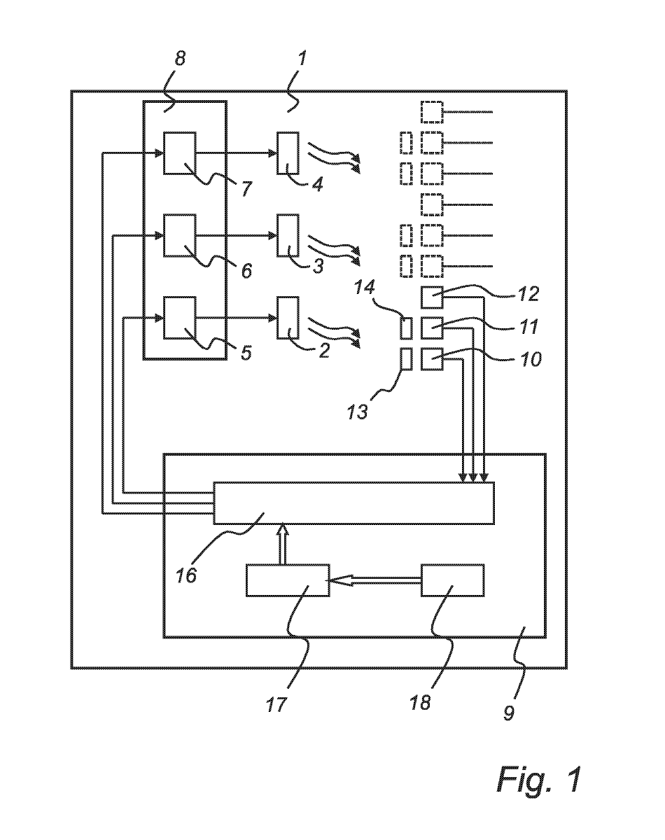

FIG. 1 is a schematic block diagram of an embodiment of a control system according to the present invention;

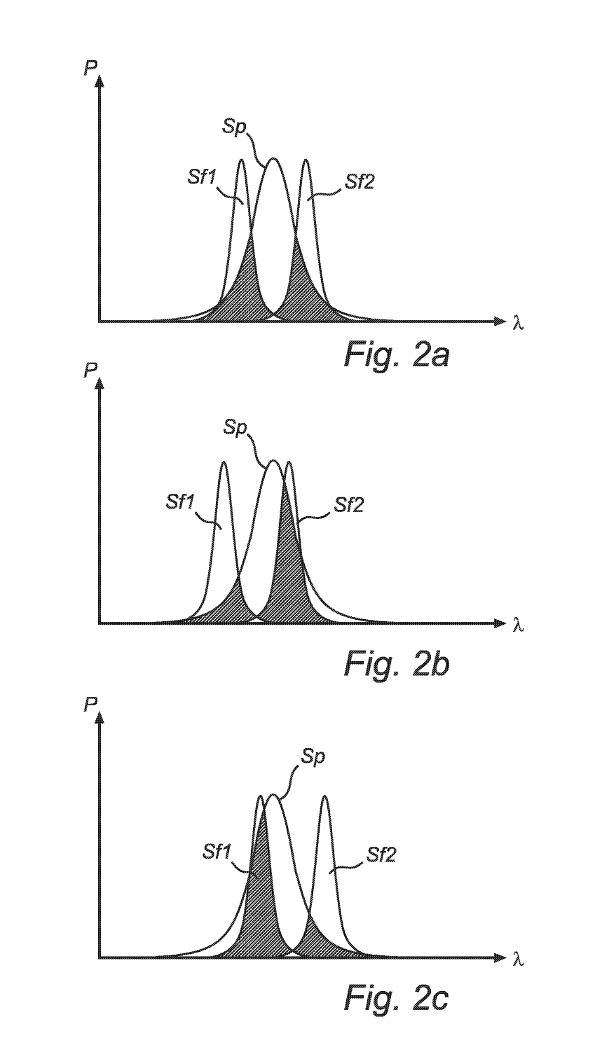

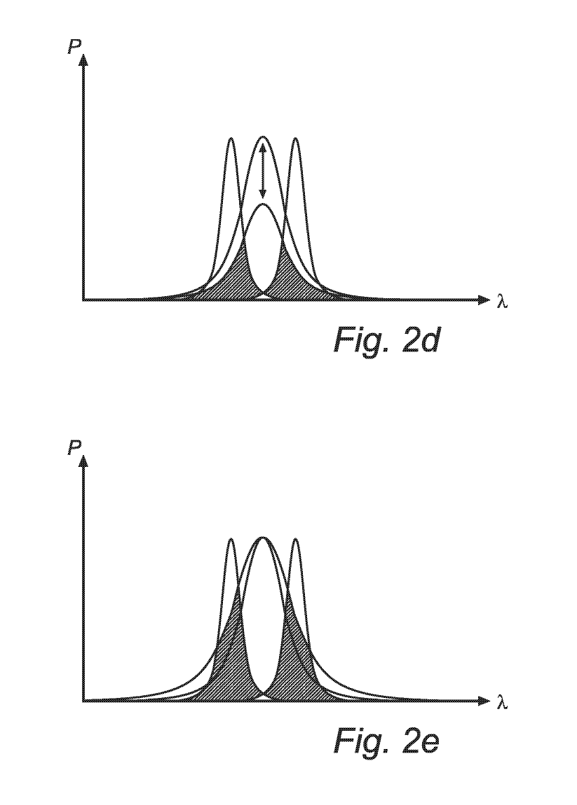

FIGS. 2a-2e and 3 schematically show spectral diagrams illustrating different spectral situations that may occur and are processed in embodiments of a method according to the present invention;

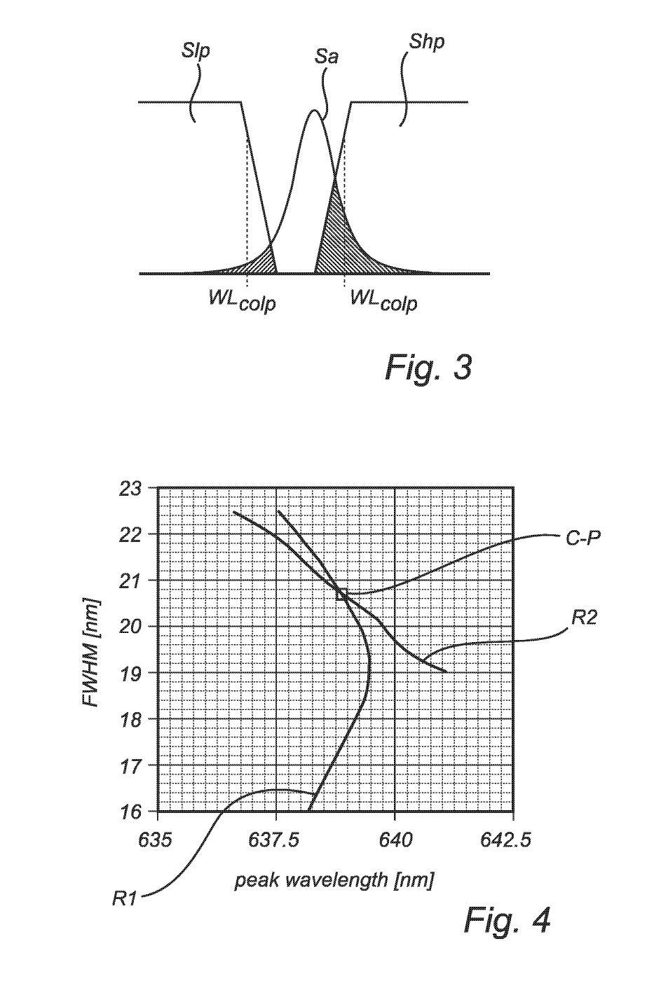

FIG. 4 is a diagram illustrating combinations of peak wavelength and FWHM for photodetector response signals; and

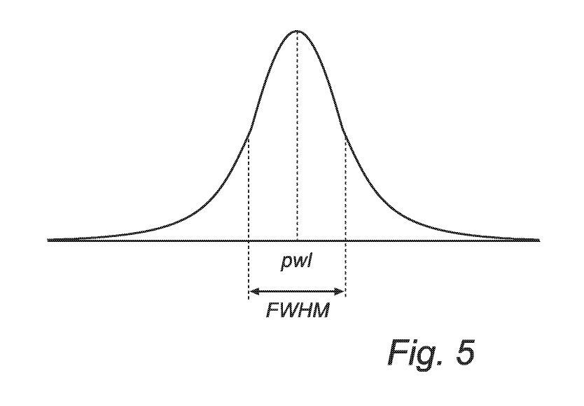

FIG. 5 is a schematic spectral graph illustrating technical terms used in this field.

FIG. 1 shows an embodiment of the control system for controlling the output of an RGB-based LED luminaire integrated in the luminaire 1. For reasons of simplicity a basic structure with very few elements is shown. Thus, the luminaire has one red, one green, and one blue LED group, or LED light source, 2-4. Each group 2-4 consists of one LED and is driven by a respective driver 5-7 of a driver device 8. The control system consists of a control device 9, three photodetectors 10-12 for each LED group 2-4, and two spectral filters 13-14 for each LED group 2-4. For two of the LED groups 2-4, the photodetectors and filters are shown in broken lines only. It is assumed that each photodetector 10-12 is provided with the appropriate amplification and signal conversion circuitry as is commonly known in the art. The photodetectors 10-12 are photodiodes, but may also be other types of photosensitive devices, such as, but not limited to, charge-coupled devices and phototransistors.

Primarily the structure and operation of the control of the red color will now be explained. The structure and operation is similar for the other colors. Each photodetector 10-12 has an output which is connected to a corresponding input of the control device 9. The filters 13, 14 are narrow-band filters, and their filter characteristics are shown in, for example, FIG. 2a. A first filter 13 of the filters 13, 14 is arranged in front of a first photodetector 10 of the photodetectors 10-12. A second filter 14 of the filters 13, 14 is arranged in front of a second photodetector 11 of the photodetectors 10-12. A third photodetector 12 of the photodetectors 10-12 receives unfiltered light from the red LED 2.

The control device 9 consists of a driver controller 16, a reference generator 17 and a user input unit 18. The user input unit 18 is connected to the reference generator 17, which in turn is connected to the driver controller 16.

This control system operates as follows.

The first photodetector 10 applies a first response signal to the driver controller 16, and the second photodetector 11 applies a second response signal thereto. The levels of the response signals are related to the amount of light that reaches the respective photodetector 10, 11. Initially, the driver 5 for the red LED 2 receives a control signal from the driver controller 16, which control signal is generated on the basis of a reference signal received by the driver controller 16 from the reference generator 17. In turn, the reference signal is generated on the basis of input data, which is input by a user via the user input unit 18. Alternatively, this data is preprogrammed in the reference generator 17.

The input data is set in order to cause the red LED 2 to emit a predefined spectrum of light which results in a desired mixed color point that corresponds to the reference signal, resulting from the input data. The predefined spectrum Sp, or more particularly the spectral density, of the light emitted from the LED 2 is illustrated in FIG. 2a. The input data is set on the basis of desired mixed color point of the LED module. The predefined spectrum is based on the LED property data as defined by the manufacturer of the LED 2. Characteristics of the first and the second filter are also illustrated in FIG. 2a, at Sf1 and Sf2, as well as in FIGS. 2b and 2c. These filter characteristics Sf1, Sf2 are at least partly non-overlapping and are set in relation to each other so that a peak level wavelength, or simply peak wavelength, of the first filter characteristic Sf1 is located at a shorter wavelength than a peak wavelength of the second filter characteristic Sf2.

Furthermore, the filter characteristics Sf1, Sf2 are set in relation to the predefined spectrum Sp so that their peak wavelengths are positioned on either side of the peak wavelength of the predefined spectrum Sp. In a more general approach, the predefined spectrum is not available, but instead a general shape and an approximate peak wavelength of the LED spectrum is assumed, and the filter characteristics Sf1, Sf2 are chosen accordingly. The assumed spectrum will be used hereinafter as a common term for any spectrum that is determined in advance. Its opposite is the actually detected spectrum of the LED 2. In this particular case, the first filter characteristic Sf1 covers a portion of the assumed spectrum Sp that is not covered by the second filter characteristic Sf2, and vice versa. This means that the second filter characteristic Sf2 covers a portion of the LED spectrum Sp which is not covered by the first filter characteristic Sf1. In this way, the response signals, which correspond to the amount of light passing the filters 10, 11, become useful for detecting any deviations of the actually emitted spectrum Sa from the assumed spectrum Sp.

As explained above, due to variations and deviations caused by inaccuracy of the manufacturing process, operational conditions, etc., the spectrum that is actually generated by the red LED 2 often differs from the assumed spectrum to some extent. If the detected spectrum of the red LED 2 is spectrally shifted towards longer wavelengths, as shown in FIG. 2b, the second response signal has a higher level than the first response signal. The driver controller 16 determines the relation between the first and second response signals by comparing them and thereby determines that the second response signal is larger than the first response signal. In addition to this comparison, there are many other ways of determining a relation between the response signals, such as determining a ratio between them. Then the driver controller 16 applies a control signal to the driver 5. The control signal increases the drive current, i.e. the forward current, to the red LED 2, whereby the emitted spectrum thereof is shifted towards shorter wavelengths. By continued control, the spectrum will become spectrally adjusted to a position in which the first and second response signals become equal or reach a predetermined ratio and are then kept in that position. In other words, the spectrum is pinned in the desired position, such as in the middle between the peak wavelengths of the first and the second filter 10, 11.

FIG. 2c shows a situation in which the detected spectrum Sd has been shifted towards shorter wavelengths as compared with the predefined spectrum Sp. Similarly to the situation just described above, the control device 9 reveals this shift and corrects the position of the detected spectrum.

In addition or as an alternative to the drive current control, peltier elements are used for heating or cooling the LEDs in order to adjust the peak wavelength towards shorter or longer wavelengths.

When the first and second filtered photodetector response signals are used, the control system is able to discriminate between a shift of the peak wavelength and an intensity change, as shown in FIG. 2d, or a spectral broadening, as shown in FIG. 2e. When the spectrum is spectrally shifted, the levels of the first and second response signals are changed in opposite directions, which changes the relation between them. If the spectrum deviates spectrally symmetrically, the levels of the first and second response signals will change in the same direction, which does not change the relation between them.

However, if it is desired to detect also spectrally symmetrical deviations, the third, unfiltered photodetector 12 comes into use. This third photodetector 12 detects the total intensity of the light emitted from the red LED 2 and applies a third response signal to the control device 9. In accordance with another embodiment, a more complex control program is implemented with this three-photodetector structure of the control system. On the basis of all three response signals, the relation determination unit 15 is programmed to compromise, if necessary, between the spectral range and the intensity of the light emitted by the LED 2, because the intensity is not allowed to decrease below a lower limit Decreasing the drive current to the LED causes a decrease in the light output and thus for some cases it might not be possible to fully adjust a shifted spectrum by decreasing the drive current because the overall intensity would become too low.

The narrow band filters 13, 14 are Fabry-Perot etalons. Such interference filters allow a very narrow spectral response and consequently have a high rejection of ambient light. It is also possible to use several different combinations of narrow-band filter characteristics by choosing different thicknesses or different indices of refraction for the dielectric layer that determines the dimension of the resonant cavity. Using these narrow-band filters, many filters can also be used in the visible spectrum in which each filter only has a small overlap with the next filter (required to make the technique work, as described above), and thus a high selectivity can be achieved.

In another embodiment having the same structure as shown in FIG. 1, the first filter 13 is a low-pass filter and the second filter 14 is a high-pass filter, as shown in FIG. 3. These filters are chosen to have relatively steep edges. The filters can then be designed in such a way that the cut-off wavelength WLcolp of the low-pass filter 13 is rather close to the cut-off wavelength WLcohp of the high-pass filter 14. A partial coverage of the LED spectrum is thereby ascertained for each filter, while still providing sufficiently large portions of individual spectrum coverage for obtaining a pronounced differential value between the two response signals when there is a spectrum deviation. In this embodiment, the spectral position of the peak of the actually emitted spectrum Sa is also adjusted until a desired relation between the filter response signals is obtained.

In another embodiment, bandpass filters having a wider passband than the narrow-band filters described above are used. This embodiment is otherwise similar to the narrow-band embodiment of the control system described above.

In another embodiment, the light output control is based on a ratio between the first and second response signals, which ratio is determined. The ratio is used for estimating the peak wavelength of the spectrum, or spectral density, of the light emitted from each LED group 2-4. In addition, the response signals are summed up. The sum is related to the overall light output of the LED group 2-4. Thus, the overall light output, i.e. the intensity or flux, of each LED group 2-4 is also estimated. The driver controller 16 is used for individually adjusting the peak wavelength as well as the overall light output of each LED group 2-4. Rather than pinning the peak wavelength, the driver controller thus estimates the peak wavelength by means of the control signals, and controls the duty cycle of the LED 2 in order to obtain a desired intensity thereof. The driver controller 16 also uses the peak wavelength estimates from all LED groups 2-4 for determining appropriate duty cycles for each one them, which jointly, i.e. when the red, green and blue light is mixed, provides a desired color point, as set by the user, or as preset.

In order to increase the accuracy of the last-mentioned control, wherein the peak wavelengths are estimated, the FWHM (Full Width at Half Maximum) is additionally determined by the driver controller 16 in a further embodiment. Since the light emitted by a LED is spectrally predictable to a substantial extent, the shape of the LED spectrum can be assumed in advance. Furthermore, the filter responses, or filter characteristics, are possible to be determined accurately in advance. Then it is possible to use the obtained response signals from the two filtered photodetectors 10, 11 and the unfiltered photodetector 12, the latter one providing the total intensity, for calculating the peak wavelength and the FWHM of the emitted spectrum of the LED 2. Subsequently, the LED spectrum estimate is calculated on the basis thereof. Knowing good estimations of the peak wavelength, intensity and width of the emitted spectrum, it is thus possible to accurately determine the color point of the LED 2. Having determined the color points of all three LEDs 2-4, the driver controller 16 determines the mixed color point. The driver controller 16 then compares this determined color point with the desired one and, if necessary, adjusts the mixed color point accordingly. This adjustment is, at least basically, performed by adjusting the duty cycles of the different LEDs 2-4.

More particularly, the basic assumption made in order to estimate both the width and the peak position of the LED spectrum is that the general spectral shape of the LED spectrum is known. For example, the LED spectrum is reasonably described by a second-order lorentzian:

$$LED\_spectrum ( λ ) = 2 \cdot {\frac{2 \cdot \sqrt{\sqrt{2} - 1}}{π \cdot ( width )} [ 1 + {( 2 \cdot \sqrt{\sqrt{2} - 1} \cdot \frac{λ - {λ}_{peak}}{width} )}^{2} ]}^{- 2} \qquad eqn . 1$$

In this embodiment, likewise as in the other embodiments mentioned above, the spectral responses of the two filters 13, 14 and their respective photodetectors 10, 11, are understood to be known. By using numerical integration, a formula for each spectral response is convoluted with the normalized assumed LED spectrum over varying widths and peak positions. A two-dimensional array wherein the photodetector response signal can be looked up as a function of peak position and width is thereby generated. For example, this integration can be performed as follows:

$$\begin{matrix}Width ( nm ) = [ 17 \; 18 \; 19 \; 20 \; 21 \; 22 \; 23 \; 24 \; 25 \; 26 ] & \\ {λ}_{peak} ( nm ) = [ 630 \; 631 \; 632 \; 633 … 647 \; 648 \; 649 ] & \\ {LED\_spectrum}_{i , j} := 2 \cdot {\frac{2 \cdot \sqrt{\sqrt{2} - 1}}{π \cdot ( {width}_{1 , i} )} [ 1 + {( 2 \cdot \sqrt{\sqrt{2} - 1} \cdot \frac{λ - {λ}_{peak , 1 , j}}{{width}_{1 , i}} )}^{2} ]}^{- 2} & eqn . 2 \\ 1 st\_resp {\_sig}_{i , j} = {\int }_{380}^{780} LED\_spectrum ( i , j , λ ) , 1 st\_filter \_func ( λ ) d λ & eqn . 3 \\ 2 nd\_resp {\_sig}_{i , j} = {\int }_{380}^{780} LED\_spectrum ( i , j , λ ) , 2 nd\_filter \_func ( λ ) d λ & eqn . 4\end{matrix}$$

These calculations are made in an initial calibration run of the photodetectors and the results are stored as look-up tables in a memory of the control device 9. As will be apparent below, the calculations can be alternatively made whenever required by the control device 9. A relation between the peak wavelength and FWHM of the LED spectrum, on the one hand, and a response signal value, on the other hand, is thus obtained for different combinations of peak wavelength and FWHM.

The detected first and second response signals are normalized to the total signal measured by the unfiltered photodetector 12. Subsequently, a search algorithm is used for each response signal so as to find all combinations of FWHM and peak wavelength in the look-up tables which result in a response signal that matches the measured one. These values are exemplified in FIG. 4, illustrating a contour plot R1, R2 for each response signal, wherein the spectral peak position (peak wavelength) is plotted on one axis and the spectral width at half maximum (FWHM) is plotted on the other axis. The common point C-P of the two determined contour plots then gives the best estimate of the FWHM and the peak position for the LED spectrum.

Based on these values, the actual spectrum is calculated. This is possible due to the assumed shape (the second-order lorentzian) of the LED spectrum. The color point is determined on the basis of this calculated spectrum. It should be noted that, as an alternative to the second-order lorentzian, any shape that provides a good approximation of the real LED spectrum is useful.

The determinations of spectral shift and overall light output are alternatively made for all LED groups jointly, for example in a time-multiplexed way, wherein all LEDs of a single color are turned on while the others are off. Furthermore, in a slight modification of this embodiment, the overall light output is additionally measured when all LEDs are off, which provides an estimate of external stray light, which is then compensated. Similarly, the influence of other LED groups on each LED group can be estimated by sequentially switching LED groups off.

In another embodiment, the control is not performed per LED group but the control device 9 is programmed to obtain response signals from the individual LED groups 2-4 and then consider them jointly for obtaining a desired color mix as a whole. For example, this may mean that, rather than adjusting each individual LED group 2-4 as close as possible to an optimal output, such as the predefined LED group spectrum, larger deviations are allowed if they provide an acceptable combined output. Minor adjustments may therefore be necessary, which in turn may have a positive influence on the overall output of color mixed light.

Embodiments of the control method and control system according to the present invention have been described hereinbefore. These embodiments should be considered as non-limiting examples only. As will be evident to a skilled person, many modifications and further alternative embodiments are possible within the scope of the invention.

As mentioned above any number, one or more, of different LED colors may be used in the luminaire. For example red, amber, green, and blue can be combined.

As has been explained with reference to the embodiments described hereinbefore, two spectrally filtered photodetectors and one unfiltered photodetector provide the possibility of either pinning a peak wavelength of a LED group or estimating the peak wavelength and adjusting the intensity of the LED on the basis thereof, or of combining these operations in order to obtain a desired color point. In a more accurate aspect, all three photodetectors in conjunction with an assumed shape of the LED spectrum are employed in determining peak wavelength and FWHM of the present LED spectrum and subsequently a color point thereof. The determined color point is then used for adjusting the light output of the LED group (one or more LEDs) in order to obtain a desired color point thereof, and/or a mixed color point of several differently colored LED groups.

It is to be noted, that for the purposes of this application, and in particular with regard to the appended claims, use of the verb “comprise” and its conjugations does not exclude other elements or steps, and use of the indefinite article “a” or “an” does not exclude a plurality of elements or steps, which will be evident to a person skilled in the art.

1. A method of controlling the output of a luminaire comprising an array of LEDs emitting light of at least one color, the array comprising single color LED groups, wherein each group consists of at least one LED, the method comprising the following steps for each LED group:
spectrally filtering the light emitted by the LED group by means of a first filter as well as by means of a second filter;
detecting the spectrally filtered light from said first and said second filter and generating respective first and second response signals, wherein the levels of said first and second response signals are related to the respective amounts of detected spectrally filtered light; and
controlling the light output of said LED group on the basis of said first and second response signals,
wherein the filter characteristics of said first and said second filter are at least partly non-overlapping.

2. A method according to claim 1, wherein the filter characteristics of said first and said second filter at least partly cover different portions of the spectrum of the light emitted by the LED group.

3. A method according to claim 1, wherein said controlling step comprises determining, on the basis of said first and second response signals, a peak wavelength of said spectrum of the light emitted by the LED group.

4. A method according to claim 3, wherein said controlling step further comprises determining, on the basis of said first and second response signals, a FWHM value of said spectrum of the light emitted by the LED group.

5. A method according to claim 4, wherein said controlling step further comprises estimating, on the basis of said peak wavelength and FWHM value, a LED spectrum estimate of said spectrum of the light emitted by the LED group.

6. A method according to claim 5, wherein said estimating step comprises assuming a shape of the spectrum of the light emitted by the LED group.

7. A method according to claim 5, wherein said controlling step further comprises determining a color point for the LED group on the basis of said LED spectrum estimate.

8. A method according to claim 3, wherein said peak wavelength is determined by means of a ratio between said levels of said first and second response signals.

9. A method according to claim 1, wherein said controlling step further comprises determining, on the basis of said first and second response signals, a FWHM value of said spectrum of the light emitted by the LED group.

10. A method according to claim 1, wherein said controlling step comprises:
moving the spectrum of the light emitted by the LED group, while repeatedly determining a relation between the first and second filter response signals until a predetermined relation is obtained.

11. A method according to claim 10, wherein said predetermined relation is unity.

12. A method according to claim 10, wherein the spectrum is moved by means of changing at least one of a drive current and a temperature of said LED group.

13. A method according to claim 10, wherein a relation of the second response with the first response increases when said spectrum of the light emitted from the LED group is moved towards longer wavelengths and decreases when said spectrum is moved towards shorter wavelengths.

14. A method according to claim 1, wherein said first and said second filter are chosen from a group of filters comprising low-pass, high-pass, bandpass and narrow-band filters.

15. A method according to claim 1, wherein the first filter is a low-pass filter and the second filter is a high-pass filter, wherein a cut-off wavelength for the first filter is located at a shorter wavelength than a cut-off wavelength for the second filter.

16. A method according to claim 1, wherein the first filter and the second filter is one of a bandpass filter and a narrow-band filter, respectively, wherein a center wavelength of the first filter is located at a shorter wavelength side of said peak wavelength and a center wavelength of the second filter is located at a longer wavelength side of said peak wavelength.

17. A method according to claim 1, wherein said first and said second filter are Fabry-Perot etalons.

18. A method according to claim 1, further comprising detecting a total light output of the LED group.

19. A method according to claim 1, further comprising detecting a total intensity of the LED group, said controlling step further comprising controlling a duty cycle of the LED group.

20. A control system for controlling the output of a luminaire comprising an array of LEDs emitting light of at least one color, the array comprising single color LED groups, wherein each group consists of at least one LED, the system comprising, for each LED group:
a first spectral filter and a second spectral filter arranged to receive the light emitted from the LED group;
a first photodetector optically connected with said first spectral filter, and a second photodetector optically connected with said second spectral filter, wherein said first and said second photodetector are arranged to detect spectrally filtered light, which has passed said first and said second spectral filter, respectively, and to generate first and second response signals, respectively, wherein the levels of said first and second response signals are related to a respective amount of the detected spectrally filtered light; and
a control device, connected with said first and said second photodetector and arranged to control the light output of said LED group on the basis of said first and second response signals, wherein the filter characteristics of said first and said second filter are at least partly non-overlapping.

21. A control system according to claim 20, wherein the filter characteristics of said first and said second filter at least partly cover different portions of the spectrum of the light emitted by the LED group.

22. A control system according to claim 20, further comprising a third photodetector which is arranged to receive the light emitted from the LED group and to generate a third response signal, wherein the level of said third response signal is related to an amount of the detected light, wherein said control device is connected with said third photodetector.

23. A control system according to claim 20, wherein said control device is arranged to determine, on the basis of said first and second response signals, a peak wavelength of said spectrum of the light emitted by the LED group.

24. A control system according to claim 23, wherein said control device is arranged to determine, on the basis of said first and second response signals, a FWHM value of said spectrum of the light emitted by the LED group.

25. A control system according to claim 24, wherein said control device is arranged to estimate, on the basis of said peak wavelength and FWHM value, a LED spectrum estimate of said spectrum of the light emitted by the LED group.

26. A control system according to claim 25, wherein said estimating step comprises assuming a shape of the spectrum of the light emitted by the LED group.

27. A control system according to claim 24, wherein said control device is arranged to determine a color point for the LED group on to basis of said peak wavelength, said FWHM and said third response signal.

28. A control system according to claim 20, wherein said control device is arranged to determine, on the basis of said first and second response signals, a FWHM value of said spectrum of the light emitted by the LED group.
